(19) United States
(12) Patent Application Publication
(10) Pub. No.: US 2025/0354937 A1
(43) Pub. Date: Nov. 20, 2025

(54) INSPECTION SYSTEM FOR INSPECTING PARTS TRAVELING ON A CONVEYOR

(71) Applicant: Applied Vision Corporation, Cuyahoga Falls, OH (US)

(72) Inventors: Bradley Glenn Maling, Cuyahoga Falls, OH (US); Joshua William Wise, Wadsworth, OH (US)

(21) Appl. No.: 18/665,507

(22) Filed: May 15, 2024

(51) Int. Cl. G01N 21/88; G01N 35/04; H04N 23/66

(52) U.S. Cl. CPC G01N 21/8806; G01N 35/04; H04N 23/66; G01N 2201/0634; G01N 2201/0636

(57) ABSTRACT

An inspection sensor system is described herein. The inspection sensor system includes a first reflector that reflects, onto an object, light of a first wavelength emitted by a first light source. The system also includes a second reflector that reflects, onto the object, light of a second wavelength emitted by a second light source. The system further includes a light diffuser that diffuses light of a third wavelength emitted by a third light source onto the object. Additionally, the system includes a camera that is configured to generate an image of the object while illuminated by the first light source, the second light source, and the third light source. The system also includes a computing system in communication with the camera, wherein the computing system is configured to receive the image generated by the camera and output an indication as to whether or not the object is defective based upon the image.

### BACKGROUND

Production plants for manufacturing containers (such as beverage cans) can produce a very large number of containers in a relatively short amount of time. Container decorations have intrinsic value, as consumers tend to attach perceptions of quality of product based upon the design and reliability of the container that holds the product. Defect detection is also important in a container production plant, as such plants can produce several thousand containers per minute. Such defects may be structural (e.g., dents, scratches, holes, etc.) or may be defects in the container decoration. Additionally, container components need to function properly to open or close correctly, to protect the contents of the container, etc.

Conventionally, there is a lack of robust inspection of exterior surfaces of containers and/or components thereof (e.g., the sides, tops, bottoms, etc.) at these container production plants. A known process for container inspection is tasking an operator at the plant to periodically sample containers and/or components thereof from a conveyor for visual inspection. For instance, every so often (e.g., every 15 minutes), the operator may be tasked with pulling a small number of containers and/or components thereof off of the conveyor and visually inspecting the containers and/or components thereof to ensure that the exterior surfaces of the containers and/or components thereof are free of readily apparent defects (e.g., to ensure that proper colors are applied to the exterior surfaces of the containers, to ensure that the exterior surfaces of the containers are free of smears, to ensure that the container ends are free of defects, to ensure the container components are free of defects that may impair their function, etc.). Using this conventional approach, hundreds of thousands of defective containers and/or components thereof may be manufactured prior to the operator noticing a defect one or more of the sampled containers and/or components thereof. In practice, these (completed) containers and/or components thereof must be scrapped, resulting in significant cost to the manufacturer.

Recently, automated systems have been developed and deployed, wherein such systems are configured, through automated visual inspection, to detect defects on exterior surfaces of containers and/or components thereof. These systems include multiple cameras that are positioned to capture images of surfaces of a container and/or components thereof when the conveyor passes through an inspection region. The images captured by the cameras are then analyzed to determine whether the surface of the container and/or components thereof includes a defect. These automated systems, however, can suffer from inaccuracies and moreover are large and expensive. Conventional inspection systems can occupy many square feet on the factory floor, cost hundreds of thousands of dollars, and take several days and technicians to install. Moreover, once installed, these bulky and expensive inspection systems cannot be moved around the factory to different inspection points without significant cost and time. Conventional inspection systems have not addressed problems associated with large inspection system size, high cost, lack of portability, and complex installation and setup.

### SUMMARY

The following is a brief summary of subject matter that is described in greater detail herein. This summary is not intended to be limiting as to the scope of the claims.

Described herein is an inspection sensor system that is configured to ascertain whether an object (e.g., a beverage end such as a top or bottom of an aluminum can or the like) being transported on a conveyor includes a defect on a surface thereof. The inspection sensor system can detect various defects on exterior surfaces of containers, including physical defects, such as dents, creases, scratches, holes, etc., that may detrimentally affect the integrity and/or appearance of a container to which the beverage end is coupled. The inspection sensor system comprises a camera that captures images of objects as they pass through a field of view of the camera and employs different wavelengths of light to highlight object structures and defects (if present) and they captured images. A computing system is configured to identify defects in the captured images and provide an indication as to whether a defect is present on an imaged object.

When illuminating the object for image capture, a plurality of light sources are employed in conjunction with a plurality of lighting elements (e.g., reflectors, light diffuser, etc.). According to one embodiment, a first light source emits light of a first wavelength into a first reflector that reflects the light of the first wavelength onto the object. A second light source emits light of a second wavelength into a second reflector that reflects the light of the second wavelength onto the object. A third light source emits light of a third wavelength through a light diffuser and on to the object. A sensor detects the presence of an object in the field of view of the camera and communicates an object presence indication to a controller or computing system, which in turn triggers the camera to capture an image of the object while the object is illuminated by light from the first, second, and third light sources.

In one embodiment, the first light source emits a red light, the second light source emits a green light, and the third light source emits a blue light. In this embodiment, defects and structures on the object are outlined in red in the captured image. In another embodiment, the first light source emits a blue light, the second light source emits a green light, and the third light source emits a red light. In this embodiment defects and structures on the object are outlined in blue in the captured image. The light sources may be, for example, light emitting diodes (LED) Arranged in a ring or the like.

The first reflector includes a first aperture that permits light reflected off of the object to pass into the camera lens. The second reflector includes a second aperture that also allows light reflected off of the object to pass into the first reflector, through the first aperture, and into the camera lens.

The elements of the inspection sensor system (i.e., the camera assembly, the first reflector, the second reflector, the light diffuser, the light sources, etc.) can be arranged along a common axis. For instance, the first reflector and the first light source can be positioned between the camera and the object to be imaged. The second reflector and the second light source can be positioned between the first reflector (and the first light source) and the object. The light diffuser and the third light source can be positioned between the second reflector (and the second light source) and the object. In this way, light from the respective light sources strikes the object at different respective angles in order to facilitate highlighting defects and structures on the object in the captured image.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a cross-sectional schematic of an inspection sensor system that facilitates detecting defects in an inspected object.

FIG. 2 shows an exploded perspective view of an inspection sensor system.

FIG. 3 is a perspective exploded view of the inspection sensor system.

FIG. 4 illustrates a side view of the assembled inspection sensor system.

FIG. 5 is a simplified cross-sectional side view of the inspection sensor system.

FIG. 6 is a perspective view of the inspection sensor system.

FIG. 7 is another perspective view of the inspection sensor system.

FIG. 8 is a bottom view of the light diffuser and the light diffuser mounting structure, under which inspected objects are passed.

FIG. 9 is an illustration of an exterior side of a beverage top.

FIG. 10 is an illustration of an interior side of the beverage top.

FIG. 11 illustrates an exemplary methodology for configuring an inspection sensor system.

FIG. 12 illustrates an exemplary methodology for operating an inspection sensor system.

FIG. 13 is an exemplary computing device.

### DETAILED DESCRIPTION

Various technologies pertaining to an object inspection system are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Further, as used herein, the term “exemplary” is intended to mean serving as an illustration or example of something and is not intended to indicate a preference.

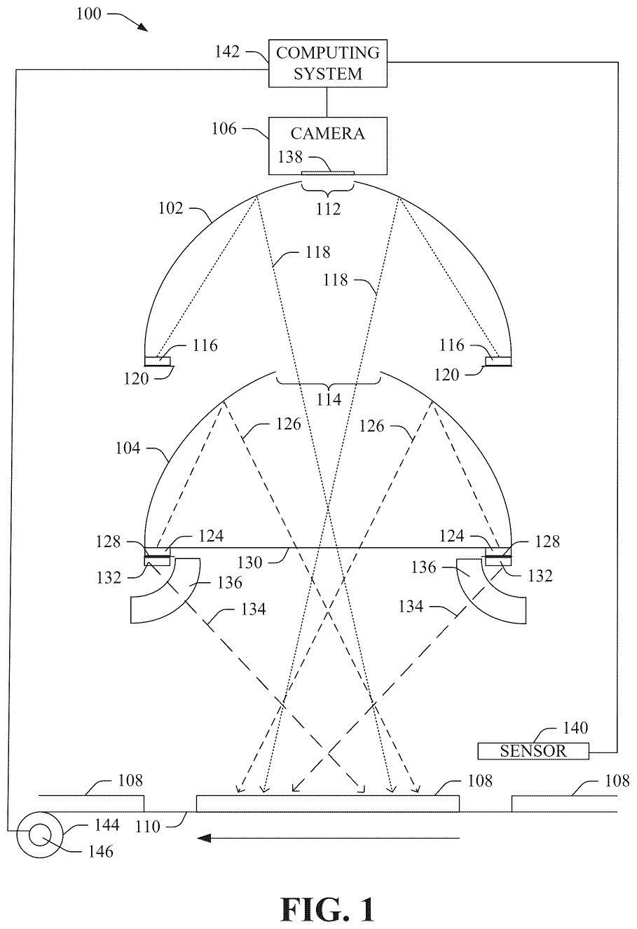

FIG. 1 is a schematic of an inspection sensor system 100 that facilitates detecting defects in an inspected object, in accordance with one or more features described herein. The inspection sensor system 100 comprises an upper reflector 102 and a lower reflector 104. A camera 106 is also shown and generates images of an object 108 on a conveyor 110 as the object 108 passes the sensor system 100. In one embodiment, the upper reflector 102 and lower reflector 104 are parabolic domes. In another embodiment, the upper and lower reflectors are spherical domes. The interior surfaces of the upper reflector 102 and the lower reflector 104 are painted or coated with a reflective material. In one embodiment, the interior surfaces of the upper reflector 102 and the lower reflector 104 are painted with acrylic flat white paint. In another embodiment, the exterior surfaces of the upper reflector 102 and the lower reflector 104 are also painted flat white. In yet another embodiment, the exterior surfaces of the upper reflector 102 and the lower reflector 104 are painted with a flat black paint to enhance image generation.

The upper reflector 102 comprises an upper reflector aperture 112 through which light reflected by the object 108 passes to the camera 106 during inspection and image generation. The lower reflector 104 comprises a lower reflector aperture 114 through which light reflected by the object 108 passes into the upper reflector 102 on its way to the camera. A portion of the light passing through the lower reflector aperture 114 can also pass through the upper reflect our aperture 112 into the camera 106 during inspection and image generation. The upper reflector 102 also comprises a first light source 116 (also referred to herein as the “upper reflector light source”) that emits light rays 118 of a first wavelength into the upper reflector, where the light rays 118 are internally reflected. Light rays 118 that pass through the lower reflector aperture 114 illuminate the object 108 being inspected. Some of the light rays 118 reach the object 108 and are reflected back through the lower reflector aperture 114 and the upper reflector aperture 112 into the camera 106 during inspection and image generation. In one embodiment, the upper reflector light source 116 is and array of LEDs arranged in a ring circumferentially on an upper LED plate 120 that is coupled to the circumferential perimeter of the upper reflector 102.

The lower reflector 104 comprises a second light source 124 (also referred to herein as the “lower reflector light source”) that emit light rays 126 of a second wavelength into the lower reflector 104, where the light rays 126 are internally reflected and illuminate the object 108 being inspected. Some of the light rays 126 are reflected off of the object 108 back through the lower reflector aperture 114 and the upper reflector aperture 112 into the camera 106 during inspection and image generation. In one embodiment, the lower reflector light source 124 is an array of LEDs arranged in a ring circumferentially on a lower LED plate 128 that is coupled to the circumferential perimeter of the lower reflector 104. A window plate 130 can be provided to keep dust and debris out of the lower reflector 104. The window plate 130 may be formed of, e.g., polycarbonate material, GORILLA GLASS®, or any other suitable material. In another embodiment, the window plate is a partially reflective one-way mirror to mitigate reflection of the camera lens in the generated images. Additionally, the window plate 130 can be coated with an antireflective coating.

The inspection sensor system 100 also comprises a third light source 132 that is positioned externally to the lower reflector 104 and emit light rays 134 of a third wavelength directly toward the object 108. In one embodiment, the third light source is an array of LEDS arranged circumferentially below the second light source. Also provided is a light diffuser 136 (shown in cross-section) through which the light rays 134 pass on their way to the object 108. Some of the light rays 134 are reflected off of the object 108 back through the lower reflector aperture 114 and the upper reflector aperture 112 into the camera 106.

The camera 106 also includes a camera aperture 138 that receives light reflected by the object 108 for image generation. The diameter of the upper reflector aperture 112 can be based upon the diameter of the camera aperture 138. In one embodiment, the upper reflector aperture 112 has a diameter that is equal to the diameter of the camera aperture 138. In another embodiment, the upper reflector aperture 112 has a diameter that is slightly larger than (e.g., 1%, 2%, 5%, etc.) the diameter of the camera aperture 138. In another embodiment, the upper reflector aperture 112 has a diameter that is slightly smaller than (e.g., 1%, 2%, 5%, etc.) the diameter of the camera aperture 138.

Regarding the wavelengths of the respective light sources, in one example, the first wavelength employed by the first light source (i.e., the upper reflector light source) 116 is the longest of the three wavelengths employed by the three respective light sources, and the third wavelength is the shortest of the three wavelengths employed by the three respective light sources. For instance, the first light source 116 may employ a wavelength that produces a red light, the second light source 124 may employ a wavelength that produces a green light, and the third light source 132 may employ wavelength that produces a blue light. Using a stack of red, green, and blue light sources in this orientation causes structures and defects on the object 108 (e.g., a beverage end or the like) to be highlighted in red in the images generated by the camera 106. Defects may include, e.g., scratches, dents, holes that may permit gases or liquids to pass through, defects that affect structural integrity, etc.

In another example, the first wavelength employed by the light source (i.e., the upper reflector light source) 116 is the shortest of the three wavelengths employed by the three respective light sources, and the third wavelength is the longest of the three wavelengths employed by the three respective light sources. For instance, the first light source 116 may employ a wavelength that produces a blue light; the second light source 124 may employ a wavelength that produces a green light; and the third light source 132 may employ wavelength that produces a red light. Using a stack of blue, green, and red light sources in this orientation causes structures and defects on the object 108 to be highlighted in blue in the images generated by the camera 106.

It will be appreciated by one of skill in the art that the forgoing examples are illustrative in nature and are not intended to limit the scope of the various features described herein. Rather, colors and wavelengths other than red, green, and blue may be employed and maybe organized in any desired order in the light source stack. That is, the light sources need not necessarily be organized in order of their relative wavelengths.

The inspection sensor system 100 further comprises a sensor 140 that outputs a signal that indicates when an object 108 on the conveyor 110 has reached an inspection region beneath the light diffuser 136. As will be described herein, the camera 106 is configured to capture images of the object 108 when the object 108 is in the inspection region. For example, and not by way of limitation, the sensor 140 may be a presence sensor that can detect when the object 108 has passed a particular point (e.g., when the object 108 has entered the inspection region). Additionally, the inspection sensor system 100 includes a conveyor drive 144 and a rotary encoder 146 that is configured to output data based upon movement of the conveyor 110. The output data, therefore, is indicative of a position of the object 108 relative to a previous position of the object 108 on the conveyor 110 and, thus, the position of the object 108 relative to the inspection region. The sensor is positioned near to and upstream of the inspection region of the inspection sensor system. The sensor 140 detects the object 108 and a computing system 142 uses information from the sensor 140 and rotary encoder-derived knowledge about the position of the object 108 to be inspected relative to the sensor 140 to cause the inspection sensor system 100 to illuminate the object 108 to be inspected and cause the camera 106 to capture the image.

The computing system 142 receives the signal output by the sensor 140. The computing system 142 can receive the signal from the sensor 140 by way of a wireless or wireline connection. The computing system 142 receives a signal from the sensor 140 when an object 106 is imminently going to be present in the inspection region. Upon receiving the signal from the sensor 140, and using information received from the rotary encoder 146, the computing system 142 triggers the camera 106 to generate an image of the object 108. The computing system 142 can comprise a processor (not shown in FIG. 1) and memory (not shown in FIG. 1) comprising instructions, classifiers, neural networks, and the like for detecting defects in images generated by the camera 106. In another embodiment, control of the light sources 116, 124, 132 is performed by the computing system 142.

According to an embodiment, the rotary encoder 146 monitors conveyor 110 position. The sensor 140 detects a leading edge of a given object 108 to be inspected, upstream of the inspection system. The computing system 142 employs a count offset parameter (e.g., in software) to determine when to capture the image of the object 108. According to a non-limiting example, if the sensor 140 is positioned a distance corresponding to three object spaces upstream of the camera 106, then the count offset parameter can be programmed based on a distance of three object spaces downstream of the sensor and a known velocity of the conveyor.

According to one aspect, the inspection sensor system(s) described herein can be employed to inspect rivet-type stay-on tab (SOT) beverage ends. In another embodiment, the inspection sensor can be employed to inspect other types of container ends (e.g., bottle caps, container ends for food cans, etc.), or other types of objects. It will be understood, however, that they described inspection sensor system(s) can be employed to inspect any desired object and is not limited to beverage ends.

In another embodiment, beam splitting elements and techniques can be employed in conjunction with colored or white light sources and using a one-way mirror that is partially reflective, in order to wash out any reflection of the camera by the object.

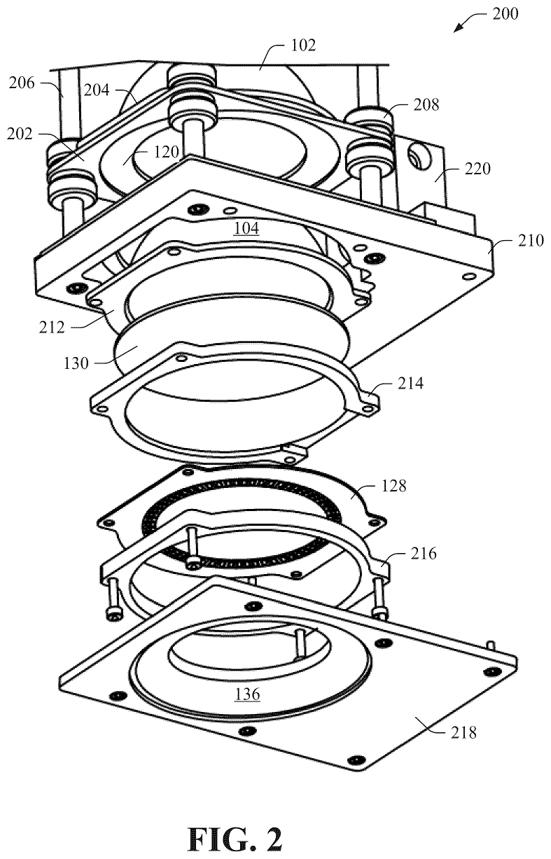

FIG. 2 shows an exploded perspective view of an inspection sensor system 200, in accordance with one or more features described herein. The inspection sensor system 200 comprises the upper reflector 102 coupled to an upper reflector mounting structure 202 at the upper reflector flange 204. In an embodiment, the upper reflector base flange 204 is integral to the upper reflector 102 (e.g., the upper reflector 102 and upper reflector base flange 204 are molded as a single structure, etc.). The upper light source plate 120 is secured between the upper reflector mounting structure 202 and the upper reflector flange 204. The upper reflector mounting structure 202 is also movably coupled to a plurality of mounting posts 206 at multiple respective corners using a plurality of bushings 208 to securely position the upper reflector 102 at a desired height above the lower reflector 104. The bases of the mounting posts 206 are securely coupled to an upper side of a lower reflector mounting structure 210.

The lower reflector 104 is coupled to the lower reflector mounting structure 210 at the lower reflector flange 212. In an embodiment, the lower reflector flange 212 is integral to the lower reflector 104 (e.g., the lower reflector 104 and lower reflector base flange 212 are molded as a single structure, etc.). A window plate 130 is positioned between the lower reflector flange 212 and a first mounting bracket 214. The window plate 130 can comprise A polycarbonate material, GORILLA GLASS®, or the like. In one embodiment, the window plate 130 is a partially reflective one-way mirror positioned to mitigate reflection of the camera by the inspected object in images of the object. The lower light source plate 128 is positioned between the first mounting bracket 214 and a second mounting bracket 216. A light diffuser 136 is positioned in a light diffuser mounting structure 218, which in turn is coupled to the lower reflector mounting structure 210. In one embodiment, the light diffuser comprises a formed translucent polystyrene layer or film. Also visible is a mounting bracket 220 for mounting the sensor system 200 to inspect objects.

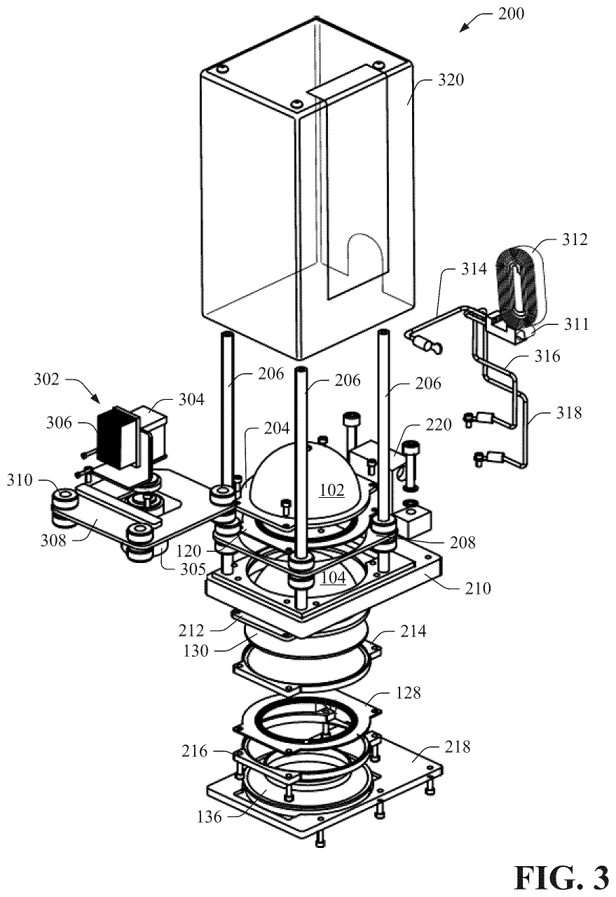

FIG. 3 is a perspective exploded view of the inspection sensor system 200, in accordance with various features described herein. Visible are the upper reflector 102 and lower reflector 104, the reflector mounting structure 202, and the upper reflector flange 204. Also shown are the mounting posts 206, bushings 208, upper light source plate 120, and lower reflector mounting structure 210. Visible below the lower reflector mounting structure 210 are the lower reflector flange 212, the window plate 130, the first mounting bracket 214, the lower light source plate 128, and the second mounting bracket 216. Also shown are the light diffuser 136, the light diffuser mounting structure 218, and the mounting bracket 220 for mounting the sensor system 200 in place to inspect objects.

Additionally, a camera assembly 302 is shown comprising a camera 304 and camera lens 305, a heat sink 306, a camera mounting plate 308, and a plurality of bushings 310 for positioning the camera assembly 302 on the mounting posts 206. In one embodiment, the camera is a red-green-blue (RGB) camera. In addition to the upper reflector mounting structure 202 being movable up and down the mounting posts 206, the camera mounting plate 308 can also be made movable up and down the mounting posts. This feature facilitates adjusting the position of the upper reflector mounting structure 202 and the position of the camera mounting plate 308 relative to the lower reflector 104.

Also shown in FIG. 3 is a protective earthing junction block 311, a ground braid 312 and a plurality of leads or cables 314, 316, 318. A camera earthing lead 314 couples the protective earthing junction block 311 to the camera 106. An upper reflector stage earthing lead 316 couples the protective earthing junction block 311 to the upper reflector 102 assembly. A lower reflector stage earthing lead 318 couples the protective earthing junction block 311 to the lower reflector 104 assembly. A cover or housing 320 that fits over the entire inspector sensor system is also illustrated.

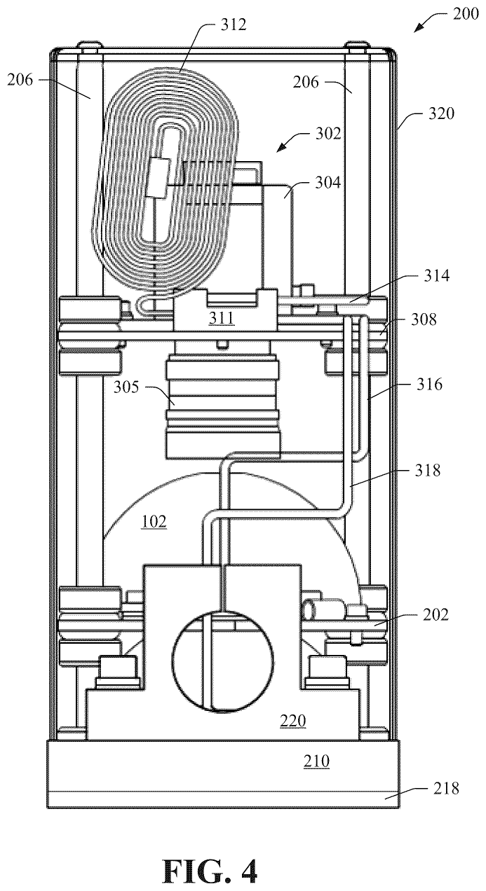

FIG. 4 illustrates a side view of the assembled inspection sensor system 200, in accordance with one or more aspects described herein. The housing 320 is shown as being transparent in FIGS. 4-7 to facilitate understanding of this structure of the assembled inspection sensor. However, according to one embodiment, the housing 320 is opaque to mitigate interference from ambient light in the operating environment of the inspection sensor system 200. For example, the housing 320 maybe formed of, e.g., aluminum or some other suitable metal, alloys of metals, plastics, etc. Inside the housing 320, the camera assembly 302 is visible and comprises the camera 304 and lens 305 mounted to the camera mounting plate 308, which in turn is movably positioned on the mounting posts 206. Also visible is the protective earthing junction block 311. The ground braid 312 is also provided. The camera earthing lead 314 couples the protective earthing junction block 311 to the camera 106. The upper reflector stage earthing lead 316 couples the protective earthing junction block 311 to the upper reflector 102 assembly. The lower reflector stage earthing lead 318 couples the protective earthing junction block 311 to the lower reflector 104 assembly. The upper reflector 102 and upper reflector mounting structure 202 are also visible in FIG. 4, while the lower reflector is obstructed by the mounting bracket 220 in the figure. The lower reflector mounting structure 210 and light diffuser mounting structure 218 are also shown.

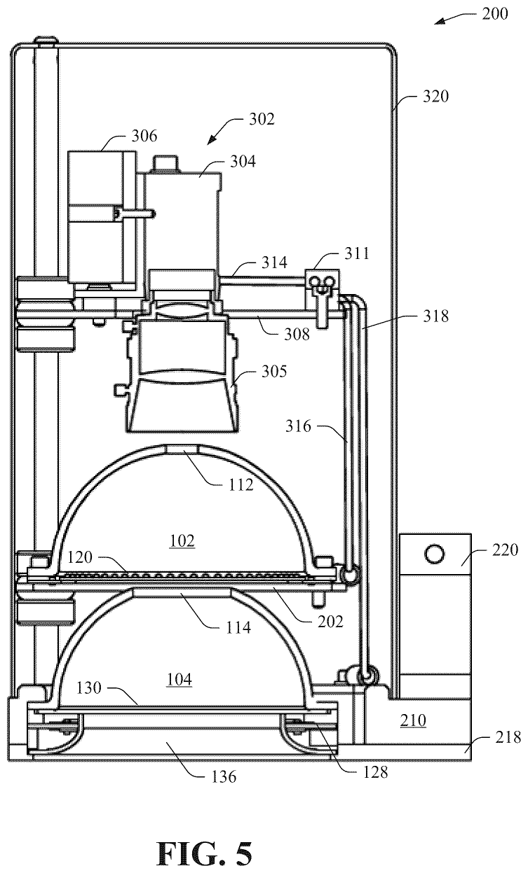

FIG. 5 is a simplified cross-sectional side view of the inspection sensor system 200 showing various aspects described herein. Visible in FIG. 5 are the upper reflector 102 mounted to the upper reflector mounting structure 202, the upper reflector aperture 112, and the upper light source plate 120. Also visible are the lower reflector 104, the lower reflector aperture 114, the window plate 130, the lower light source plate 128. The lower reflector mounting structure 210 is also shown coupled to the light diffuser mounting structure 218 with the light diffuser 136 installed therein. Mounting post 206 is visible, to which the upper reflector mounting structure 202 is mounted. The mounting post 206 is coupled to the lower reflector mounting structure 210.

Above the upper reflector 102 in the inspection sensor housing 320 is the camera assembly 302, comprising the camera 304 and camera lens 305, the heat sink 306, mounted to the camera assembly mounting structure 308. The camera assembly mounting structure 308 in turn is coupled to the mounting post(s) 206. Earthing leads 314, 316, 318 are also shown coupled to the protective earthing junction block 311 and provide the functionality described with regard to the preceding figures. Mounting bracket 220 is also visible. The ground braid 312 is not shown in FIG. 5.

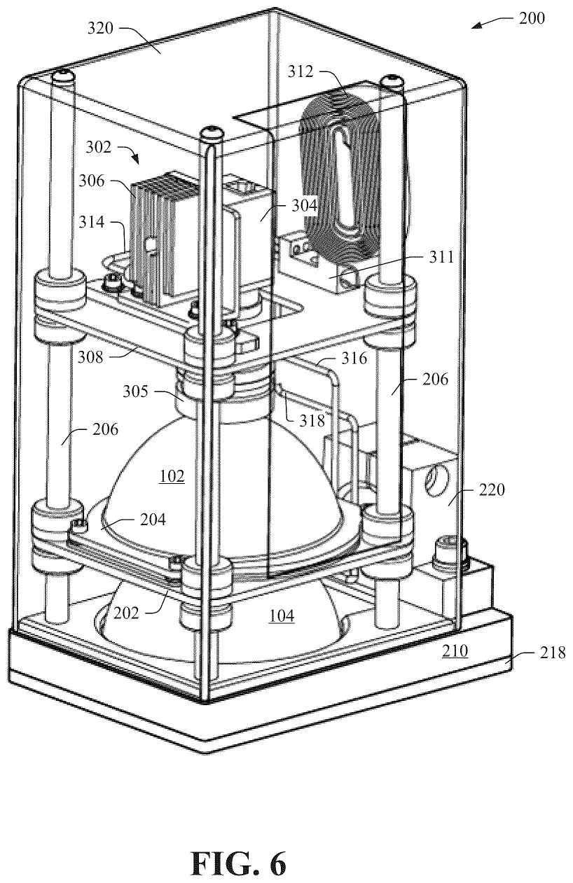

FIG. 6 is a perspective view of the inspection sensor system 200, showing various aspects described herein. Shown in FIG. 6 are the upper reflector 102 mounted to the upper reflector mounting structure 202 by the upper reflector flange 204. Also visible are the lower reflector 104 and the lower reflector mounting structure 210, which in turn is coupled to the light diffuser mounting structure 220. Mounting posts 206 are shown, to which the upper reflector mounting structure 202 is mounted. The mounting posts 206 are coupled to the lower reflector mounting structure 210. The light diffuser mounting structure 218 is coupled to the lower reflector mounting structure 210.

Also visible within the inspection sensor housing 320 is the camera assembly 302, comprising the camera 304 and camera lens 305, and the heat sink 306, mounted to the camera assembly mounting structure 308. The camera assembly mounting structure 308 in turn is coupled to the mounting post(s) 206. Earthing leads 314, 316, 318 are also shown and provide the functionality described with regard to the preceding figures. Mounting bracket 220 and ground braid 312 are also visible.

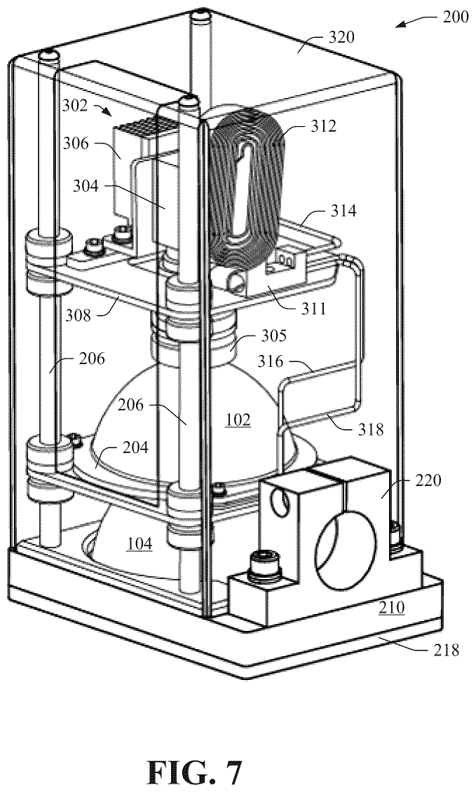

FIG. 7 is another perspective view of the inspection sensor system 200, showing various aspects described herein. FIG. 7 shows the upper reflector 102 mounted to the upper reflector mounting structure 202 by the upper reflector flange 204. Also visible are the lower reflector 104 and the lower reflector mounting structure 210, which in turn is coupled to the light diffuser mounting structure 220. Mounting posts 206 are shown, to which the upper reflector mounting structure 202 is mounted. The mounting posts 206 are coupled to the lower reflector mounting structure 210. The light diffuser mounting structure 218 is coupled to the lower reflector mounting structure 210.

Also visible within the inspection sensor housing 320 is the camera assembly 302, comprising the camera 304 and camera lens 305, and the heat sink 306, mounted to the camera assembly mounting structure 308. The camera assembly mounting structure 308 in turn is coupled to the mounting post(s) 206. Leads 314, 316, 318 are also shown and provide the functionality described with regard to the preceding figures. Mounting bracket 220 and ground braid 312 are also visible.

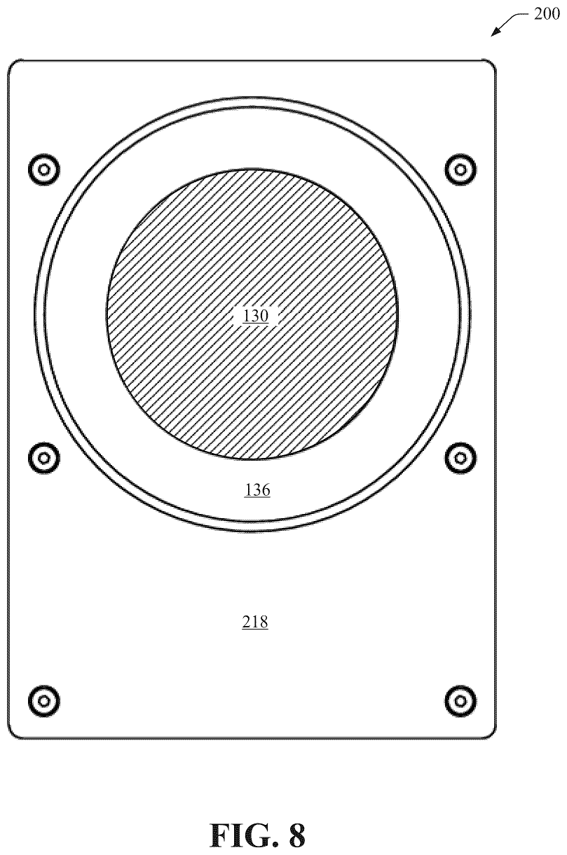

FIG. 8 is a bottom view of the inspection sensor system 200 showing light diffuser 136 and the light diffuser mounting structure 218, under which inspected objects are passed. The window plate 130 is also visible, through which light can pass from the upper reflector and lower reflector of the described assemblies to illumination an object passing under the inspection sensor system 200. In one embodiment, the aperture of the light diffuser 136 through which the window plate 130 is visible is approximately 3 inches in diameter to accommodate a typical beverage top (e.g., a pull-tab or pop-top beverage can top or the like). In another embodiment, the light diffuser aperture is made smaller for inspecting smaller objects, such as bottlecaps or the like. It will be understood by one of skill in the art that the foregoing examples are illustrative in nature and not to be construed any limiting sense. Rather, the light diffuser aperture can be any suitable diameter for imaging a respective object.

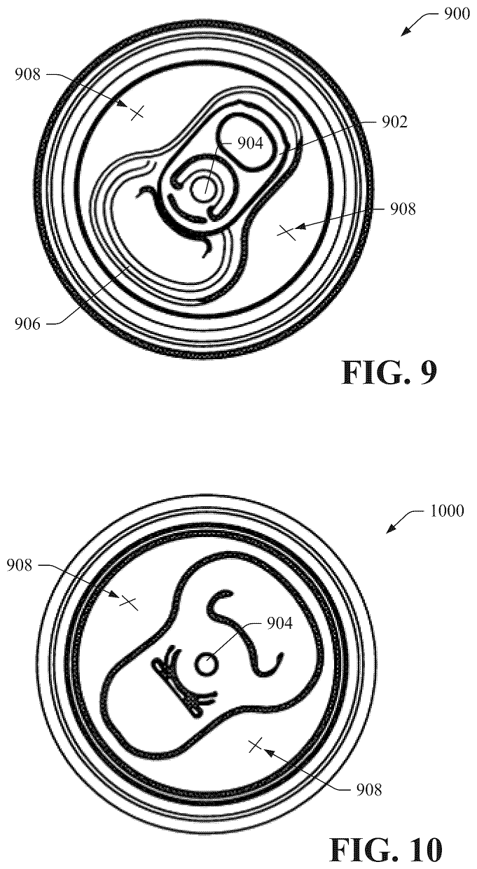

FIG. 9 is an illustration of an exterior side of a beverage top 900 such as maybe employed on the top of an aluminum beverage can or the like. The beverage top 900 may comprise multiple features, including a pull tab 902, a rivet 904, a main score where the beverage top opens when the pull tab is actuated, etc. Also visible on the beverage top 900 are minor defects 908 (e.g., scratches, dents, etc.) that can detrimentally affect the integrity of the beverage top 900.

FIG. 10 is an illustration of an interior side of the beverage top 900. The rivet 904 is visible as are the defects 908.

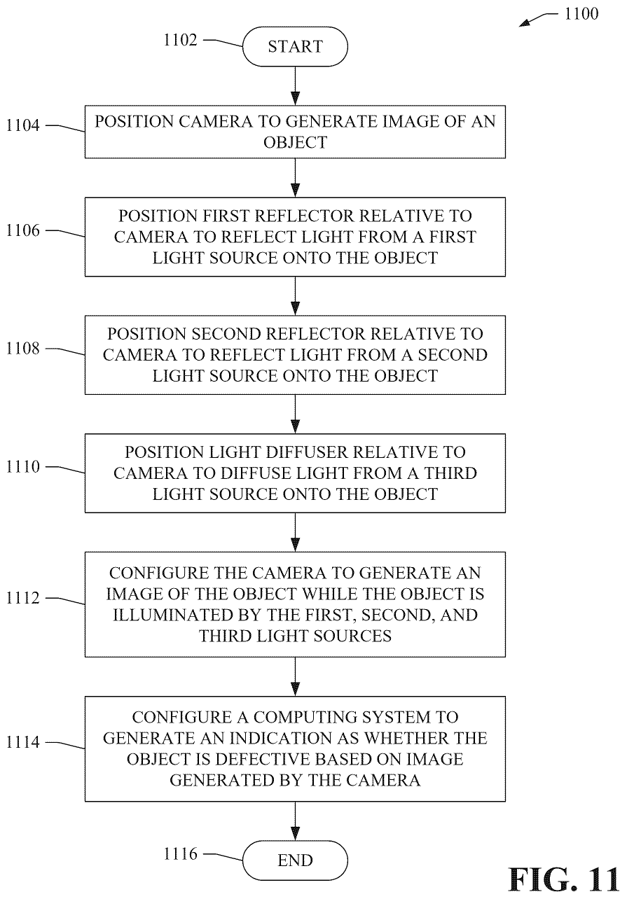

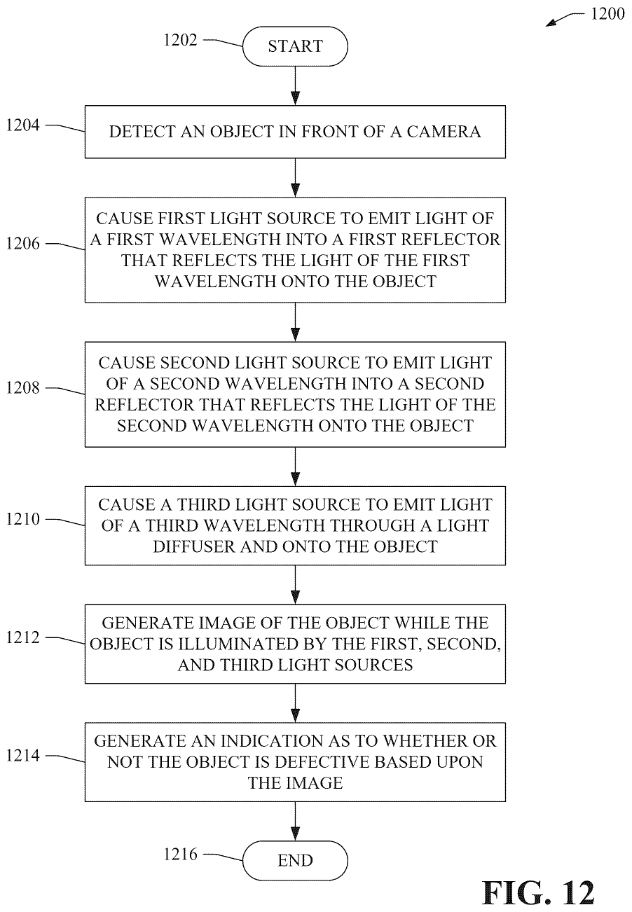

FIGS. 11-12 illustrate exemplary methodologies relating to configuring and operating an inspection sensor system. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Now referring to FIG. 11, an exemplary methodology 1100 for configuring an inspection sensor system is illustrated. The methodology 1100 starts at 1102, and 1104 camera is positioned to generate an image of an object. In one embodiment, the camera is positioned to generate images of respective objects as they pass in front of the camera on a conveyor or the like. According to an example, the object is a beverage end, such as a can top or the like. At 1106, a first reflector is positioned relative to the camera to reflect light from a first light source onto the object. At 1108, A second reflector is positioned relative to the camera to reflect light from a second light source onto the object. At 1110, a light diffuser is positioned relative to the camera to diffuse light from a third light source onto the object. In one embodiment, the first, second, and third light sources each employ different wavelengths of light. For example, the first light source may emit a red light, the second light source a green light, and the third light source a blue light. In another example the first light source emits a blue light, the second light source green light, and the third light source a red light. It will be understood by one of skill in the art that the foregoing examples are illustrative in nature and that the subject light sources described herein are not limited to emitting red, blue, and green light.

At 1112, the camera is configured to generate an image of the object while the object is illuminated by the first, second, and third light sources. At 1114, a computing system is configured to generate an indication as to whether the object is defective based on the image generated by the camera. The methodology 1100 completes at 1116.

Referring now to FIG. 12, an exemplary methodology 1200 that facilitates operating an inspection sensor system is illustrated. The methodology 1200 starts at 1202, and at 1204 and object is detected in front of a camera. In one embodiment, the object is moving past the camera on a conveyor and is detected for imaging as it passes in front of the camera. The object may be, for example, a beverage end such as a can top or bottom, a bottle cap, or the like.

At 1206, a first light source emits light of a first wavelength into a first reflector that reflects the light of the first wavelength onto the object. At 1208, a second light source emits light of a second wavelength into a second reflector that reflects the light of the second wavelength onto the object. At 1210, a third light source emits light of a third wavelength through a light diffuser and onto the object. In one embodiment, the first, second, and third light sources each employ different wavelengths of light. For example, the first light source may emit a red light, the second light source a green light, and the third light source a blue light. In another example the first light source emits a blue light, the second light source green light, and the third light source a red light. It will be understood by one of skill in the art that the foregoing examples are illustrative in nature and that the subject light sources described herein are not limited to emitting red, blue, and green light.

At 1212, an image is generated (captured or the like) for analysis by a computing system by the camera of the object while the object is illuminated by the first, second, and third light sources. At 1214, an indication is generated and output by the computing system regarding whether or not the object is defective. The indication can be generated by a computing system that is trained to identify defects on the objects as they pass in front of the camera on a conveyor. The methodology 1200 completes at 1216.

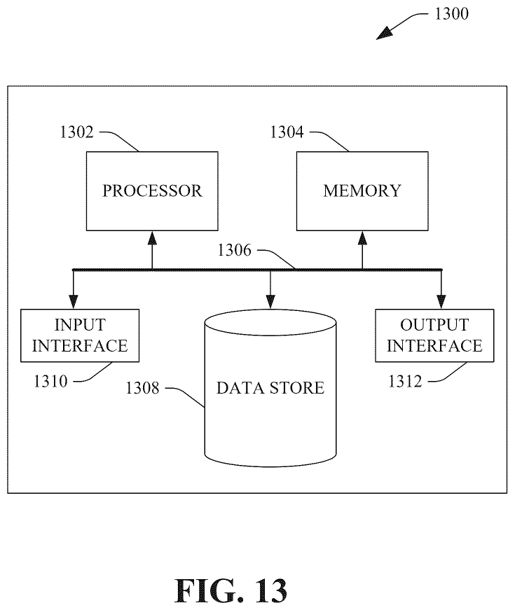

Referring now to FIG. 13, a high-level illustration of an exemplary computing device 1300 that can be included in the computing system 142 and/or the control component 311 is illustrated. The computing device 1300 includes at least one processor 1302 that executes instructions that are stored in a memory 1304. The instructions may be, for instance, instructions for implementing functionality described as being carried out by the computing system 142, as described above. The processor 1302 may access the memory 1304 by way of a system bus 1306. In addition to storing executable instructions, the memory 1304 may also store images, threshold values, etc.

The computing device 1300 additionally includes a data store 1308 that is accessible by the processor 1302 by way of the system bus 1306. The data store 1308 may include executable instructions, images, etc. The computing device 1300 also includes an input interface 1310 that allows external devices to communicate with the computing device 1300. For instance, the input interface 1310 may be used to receive instructions from an external computer device, from a user, etc. The computing device 1300 also includes an output interface 1312 that interfaces the computing device 1300 with one or more external devices. For example, the computing device 1300 may display text, images, etc. by way of the output interface 1312.

It is contemplated that the external devices that communicate with the computing device 1300 via the input interface 1310 and the output interface 1312 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1300 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1300 may be a distributed system. Thus, for instance, several devices may be in communication by way of a network connection and may collectively perform tasks described as being performed by the computing device 1300.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Various features have been disclosed herein that accord to at least the following examples.
(A1) In an aspect, an inspection sensor system includes a first light source that emits first light of a first wavelength and a first reflector that reflects the first light emitted by the first light source onto an object. The inspection sensor system also includes a second light source that emits second light of a second wavelength and a second reflector that reflects the second light emitted by the second light source onto the object. The inspection sensor system additionally includes a third light source that emits light of a third wavelength and a light diffuser that diffuses the third light emitted by the third light source onto the object. The inspection sensor system further includes a camera that is configured to generate an image of the object while the object is illuminated by the first light source, the second light source, and the third light source. The inspection sensor system also includes a computing system in communication with the camera, where the computing system is configured to receive the image generated by the camera and output an indication as to whether or not the object is defective based upon the image.
(A2) In some embodiments of the inspection sensor system of (A1), the first reflector is positioned between the camera and the object, the second reflector is positioned between the first reflector and the object, and the light diffuser is positioned between the second reflector and the object.
(A3) In some embodiments of the inspection sensor system of at least one of (A1)-(A2), the first reflector includes a first reflector aperture through which light from the first, second, and third light sources is reflected by the object into the camera. Further, the second reflector includes a second reflector aperture through which light from the first, second, and third light sources is reflected by the object into the camera. Moreover, the second aperture is larger than the first aperture.
(A4) In some embodiments of the inspection sensor system of (A3), the size of the first aperture is based on a size of a camera lens aperture of a lens coupled to the camera.
(A5) In some embodiments of the inspection sensor system of at least one of (A1)-(A4), the first and second reflectors are parabolically shaped.
(A6) In some embodiments of the inspection sensor system of at least one of (A1)-(A5), the light diffuser comprises a translucent polystyrene film.
(A7) In some embodiments of the inspection sensor system of at least one of (A1)-(A6), the first light source emits red light, the second light source emits green light, and the third light source emits blue light.
(A8) In some embodiments of the inspection sensor system of at least one of (A1)-(A6), first light source emits blue light, the second light source emits green light, and the third light source emits red light.
(A9) In some embodiments of the inspection sensor system of at least one of (A1)-(A8), the camera, the first reflector, the second reflector, the light diffuser, the first light source, the second light source, and the third light source are mounted along a common axis.
(A10) In some embodiments of the inspection sensor system of (A9), the first reflector and the camera are moveable along the common axis.
(A11) In some embodiments of the inspection sensor system of at least one of (A1)-(A10), the inspection sensor system also includes a window layer coupled to a flange of the second reflector.
(A12) In some embodiments of the inspection sensor system of at least one of (A1)-(A11), an opaque housing encases the inspection sensor system.
(A13) In some embodiments of the inspection sensor system of at least one of (A1)-(A12), the inspection sensor system also includes a sensor that is in communication with the computing system, where the computing system is configured to cause the camera to capture an image based upon a signal output by the sensor, the signal output by the sensor indicative of a position of the object on a conveyor relative to the camera.
(B1) In another aspect, a method for configuring an inspection sensor system includes positioning relative to a camera a first reflector that reflects, onto an object, first light of a first wavelength emitted by a first light source. The method also includes positioning relative to the camera a second reflector that reflects, onto the object, second light of a second wavelength emitted by a second light source. The method additionally includes positioning relative to the camera a light diffuser that diffuses third light of a third wavelength emitted by a third light source onto the object. The method further includes configuring the camera to generate an image of the object while the object is illuminated by the first, second, and third light sources. The method also includes configuring a computing system to: 1) receive the image generated by the camera; and 2) generate an indication as to whether or not the object is defective based upon the image generated by the camera.
(B2) In some embodiments of the method of (B1), the method also includes positioning the first reflector between the camera and the object, the second reflector between the first reflector and the object, and the light diffuser between the second reflector and the object.
(B3) In some embodiments of the method of at least one of (B1)-(B2), the first light source emits red light, the second light source emits green light, and the third light source emits blue light.
(B4) In some embodiments of the method of at least one of (B1)-(B3), the method also includes positioning the camera, the first reflector, the second reflector, the light diffuser, the first light source, the second light source, and the third light source along a common axis.
(C1) In another aspect, a method of operating an inspection sensor system includes monitoring a position of a conveyor with a rotary encoder. The method also includes detecting a leading edge of an object upstream of a camera. The method additionally includes employing an encoder count offset parameter to determine when the object is in a field of view of the camera. The method further includes causing a first light source to emit first light of a first wavelength into a first reflector that reflects the light of the first wavelength onto the object. The method also includes causing a second light source to emit second light of a second wavelength into a second reflector that reflects the light of the second wavelength onto the object. The method additionally includes causing a third light source to emit third light of a third wavelength through a light diffuser and onto the object. The method further includes generating an image of the object while the object is illuminated by the first, second, and third light sources. The method also includes generating an indication as to whether or not the object is defective based upon the image.
(C2) In some embodiments of the method of (C1), the first reflector is positioned between the camera and the object, second reflector is positioned between the first reflector and the object, and the light diffuser is positioned between the second reflector and the object.
(C3) In some embodiments of the method of at least one of (C1)-(C2), the camera, the first reflector, the second reflector, the light diffuser, the first light source, the second light source, and the third light source are positioned along a common axis.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An inspection sensor system comprising;
a first light source that emits first light of a first wavelength;
a first reflector that reflects the first light emitted by the first light source onto an object;
a second light source that emits light of a second wavelength;
a second reflector that reflects the second light emitted by the second light source onto the object;
a third light source that emits third light of a third wavelength;
a light diffuser that diffuses light emitted by the third light source onto the object;
a camera that is configured to generate an image of the object while the object is illuminated by the first light source, the second light source, and the third light source; and
a computing system in communication with the camera, wherein the computing system is configured to receive the image generated by the camera and output an indication as to whether or not the object is defective based upon the image.

2. The inspection sensor system of claim 1, wherein the first reflector is positioned between the camera and the object, the second reflector is positioned between the first reflector and the object, and the light diffuser is positioned between the second reflector and the object.

3. The inspection sensor system of claim 1, wherein:
the first reflector comprises a first reflector aperture through which light from the first, second, and third light sources is reflected by the object into the camera;
the second reflector comprises a second reflector aperture through which light from the first, second, and third light sources is reflected by the object into the camera;
wherein the second aperture is larger than the first aperture.

4. The inspection sensor system of claim 3, wherein the size of the first aperture is based on a size of a camera lens aperture of a lens coupled to the camera.

5. The inspection sensor system of claim 1, wherein the first and second reflectors are parabolically shaped.

6. The inspection sensor system of claim 1, wherein the light diffuser comprises a translucent polystyrene film.

7. The inspection sensor system of claim 1, wherein the first light source emits red light, the second light source emits green light, and the third light source emits blue light.

8. The inspection sensor system of claim 1, wherein first light source emits blue light, the second light source emits green light, and the third light source emits red light.

9. The inspection sensor system of claim 1, wherein the camera, the first reflector, the second reflector, the light diffuser, the first light source, the second light source, and the third light source are mounted along a common axis.

10. The inspection sensor system of claim 9, wherein the first reflector and the camera are moveable along the common axis.

11. The inspection sensor system of claim 1, further comprising a window layer coupled to a flange of the second reflector.

12. The inspection sensor system of claim 1, wherein an opaque housing encases the inspection sensor system.

13. The inspection sensor system of claim 1, further comprising a sensor that is in communication with the computing system, wherein the computing system is configured to cause the camera to capture an image based upon a signal output by the sensor, the signal output by the sensor indicative of a position of the object on a conveyor relative to the camera.

14. A method for configuring an inspection sensor system, the method comprising:
positioning relative to a camera a first reflector that reflects, onto an object, first light of a first wavelength emitted by a first light source;
positioning relative to the camera a second reflector that reflects, onto the object, second light of a second wavelength emitted by a second light source;
positioning relative to the camera a light diffuser that diffuses third light of a third wavelength emitted by a third light source onto the object; and
configuring the camera to generate an image of the object while the object is illuminated by the first, second, and third light sources; and
configuring a computing system to:
receive the image generated by the camera; and
generate an indication as to whether or not the object is defective based upon the image generated by the camera.

15. The method of claim 14, further comprising positioning the first reflector between the camera and the object, second reflector between the first reflector and the object, and the light diffuser between the second reflector and the object.

16. The method of claim 14, wherein the first light source emits red light, the second light source emits green light, and the third light source emits blue light.

17. The method of claim 14, further comprising positioning the camera, the first reflector, the second reflector, the light diffuser, the first light source, the second light source, and the third light source along a common axis.

18. A method of operating an inspection sensor system, the method comprising:
monitoring a position of a conveyor with a rotary encoder;
detecting a leading edge of an object upstream of a camera;
employing an encoder count offset parameter to determine when the object is in a field of view of the camera;
causing a first light source to emit first light of a first wavelength into a first reflector that reflects the light of the first wavelength onto the object;
causing a second light source to emit second light of a second wavelength into a second reflector that reflects the light of the second wavelength onto the object;
causing a third light source to emit third light of a third wavelength through a light diffuser and onto the object;
generating an image of the object while the object is illuminated by the first, second, and third light sources; and
generating an indication as to whether or not the object is defective based upon the image.

19. The method of claim 18, wherein the first reflector is positioned between the camera and the object, second reflector is positioned between the first reflector and the object, and the light diffuser is positioned between the second reflector and the object.

20. The method of claim 18, wherein the camera, the first reflector, the second reflector, the light diffuser, the first light source, the second light source, and the third light source are positioned along a common axis.
